(19) United States
(12) Patent Application Publication
(10) Pub. No.: US 2012/0235849 A1
(43) Pub. Date: Sep. 20, 2012

(54) METHOD AND APPARATUS FOR THROUGH THE WALL RADAR IMAGING

(76) Inventors: James Z. Tatoian, Pasadena, CA (US); Giorgio Franceschetti, Santa Monica, CA (US)

(21) Appl. No.: 13/299,885

(22) Filed: Nov. 18, 2011

Related U.S. Application Data
(60) Provisional application No. 61/415,769, filed on Nov. 19, 2010.

(51) Int. Cl. G01S 13/89

(52) U.S. Cl. 342/21; 342/22

(57) ABSTRACT

The present invention comprises a method for through the wall radar imaging. An impulse synthetic aperture radar system transmits short, ultra-wideband carrierless microwave pulses at an obstacle behind which a target of interest is located. The return signals are received, stored and analyzed. Portions of the return signals that represent reflections from the obstacle are identified and analyzed in the time domain to estimate the transmission coefficient of the wall, either by estimating wall parameters or by using a novel shift and add procedure. The estimated transmission coefficient is used to filter the received signals to reduce the components of the received signal that are generated by the obstacle, and to compensate for distortion caused by the obstacle in the portions of the transmitted signal that are reflected by the target and returned, through the obstacle, to the radar system.

### CROSS-REFERENCE TO RELATED APPLICATION

This patent application claims the benefit of the filing date of U.S. Provisional Patent Application No. 61/415,769 filed Nov. 19, 2010.

### BACKGROUND OF THE INVENTION

(1) Field of the Invention

The present invention relates to a method and apparatus for through the wall imaging and in particular to a method and apparatus for through the wall imaging that comprises a novel method for compensating for the effects of a wall or other obstacle between a radar device and a target.

(2) Description of the Related Art

Imaging of inaccessible targets is an important problem for a number of applications. Detection of people buried under the remnants of a building destroyed by an earthquake is a pertinent example. Investigation from outside the building of the presence of terrorists or hostages inside a room with shielded windows is another important application. A possible non-invasive imaging technique is the use of a radar system that radiates electromagnetic waves toward the region where the target may be present but not visible. Those waves penetrate the shielding obstacle (e.g. wall or shielded window), hit the target (if present), are reflected by the target back through the shielding obstacle, and are received by the radar system. Then, after appropriate processing of the received data, a radar image of the reflected waves is obtained. This process is sometimes referred to as “through the wall radar imaging” or “TWRI.”

In principle, TWRI is similar to the operation of conventional radar systems. For instance, in any airport the radar systems explore the sky by radiating electromagnetic waves to check the presence of airplanes. If an airplane is present, it reflects the incoming wave, and detection and processing of the reflected signal at the radar station provides two types of information: presence and location of the aircraft. Additional information might be also obtained by more sophisticated radar systems.

There is a fundamental difference, however, between TWRI and conventional radar imaging: in conventional radar imaging, no intermediate shielding obstacle is present in-between the target, i.e., the aircraft, and the detection instrument, i.e., the radar system.

In TWRI, the interceding shielding obstacle causes a number of issues. One is that the shielding obstacle reduces the power of both the electromagnetic waves that impact the target, as well as the waves that are reflected from the target back to the radar receiver. A second is that the shielding obstacle itself produces multiple reflections of the transmitted radar signal that also are received by the radar receiver. Finally, the obstacle distorts the waveform that impinges on it and thus distorts the waveform received back at the receiver, which ultimately results in the radar image degradation.

FIG. 1 shows a schematic illustration of a simple TWRI scenario. As shown in FIG. 1, the scenario consists of a radar station 110 on one side of a wall 120, with the target 130 of interest on the other side of wall 120. Radar station 110 sends out a radar signal (e.g. a microwave signal) 115 in the direction of wall 120. For simplicity, signal 115 is shown as a single ray that is emitted normal (perpendicular) to wall 120 (i.e., incident angle is zero).

The propagation of signal 115 after it is emitted by radar station 110 may be described generally as follows. Signal 115 travels through the air from radar station 110 until it hits the front surface 122 of wall 120. Signal 115 is partly reflected by front surface 122 of wall 120. Then, reduced by the reflected amount, signal 115 traverses through wall 120 until it reaches back surface 124 of wall 120. As signal 115 traverses through wall 120, it is reduced in magnitude by an amount that depends generally on the wall thickness and permittivity and conductivity of the wall material. When reduced signal 115 impinges back surface 124 of wall 120, it is again partly reflected. The remaining portion of signal 115 emerges from wall 120 and hits target 130, and is partially reflected by target 130 back towards wall 120. At wall 120, it is again partly reflected back away from the wall, and partly penetrates the wall, traversing the wall from back surface 124 to front surface 122. At front surface 122, after being reduced in magnitude by its traversal of wall 120, it is again partly reflected. The remaining part emerges from front surface 122 of wall 120 to be finally received by radar station 110.

This is not, however, the only part of original signal 115 that is received by radar station 110. It will be recalled that when signal 115 first hits front surface 122 of wall 120, a portion is reflected. This first reflected portion is the first portion of signal 115 that is received by radar station 110. It will also be recalled that when signal 115 first hits back wall 124 of wall 120, another, second portion, is reflected back inside wall 120. This second reflected portion traverses from back surface 124 to front surface 122 of wall 120, where, again, part is reflected. The remaining part emerges from front surface 122 of wall 120 and is received by radar station 110. This pattern is repeated again and again for each of the reflected portions of signal 115, although with field intensities successfully decreasing, but in any case different from zero. Accordingly, as signal 115 moves along back and forth directions inside wall 120, successive increasingly attenuated replicas of transmitted signal 115 are received at radar station 110.

FIG. 2 is a schematic time-space diagram illustrating the propagation of signal 115 as described above. In FIG. 2, the vertical axis is a time line and radar station 110, wall 120 and target 130 are elongated along the time axis to help conceptualize how the various reflected and transmitted portions of signal 115 behave over time.

As shown at the top left of FIG. 2, original signal 115 is emitted from a transmitter 110 at time t₀ in the direction of wall 120. When original signal 115 impinges on front surface 122 of wall 120, it is partly reflected back towards radar station 110 (due to the difference in permittivity between the air and the wall) and partly transmitted into wall 120. The reflected part is shown as ray 200 in FIG. 2. The transmitted part of original signal 115 is shown as ray 202 in FIG. 2. The magnitude of ray 202, as it enters wall 120, is generally equal to the magnitude of original signal 115 minus the magnitude of reflected part 200. Assume that the original signal 115 has a unit magnitude equal to 1. Let Γ equal the proportion of an impinging signal that is reflected at front surface 122. Then the magnitude of reflected part 200 is Γ, and the magnitude of the transmitted part as it enters wall 120 at front surface 122 is 1−Γ. As shown in FIG. 2, reflected ray 200 is received by radar station 110 with magnitude Γ at time t₁.

Transmitted ray 202 proceeds through wall 120 from front surface 122 to back surface 124. As it proceeds through wall 120, ray 202 is attenuated by a proportion that is dependent on the permittivity and conductivity of wall 120, and its thickness. Let Φ equal the proportion of ray 202 that is attenuated by its traversal of wall 120. Then the magnitude of ray 202 as it arrives at back surface 124 of wall 120 is (1−Γ)Φ.

At back surface 124 of wall 120, a portion of ray 202 is reflected back into wall 120 as ray 204, and the remainder is transmitted through back surface 124 towards target 130 as ray 206. Assuming the reflection at the wall/air interface at back surface 124 is the same as at the wall/air interface at front surface 122, then the magnitude of reflected ray 204 is Γ(1−Γ)Φ. The magnitude of transmitted ray 206 is the magnitude of attenuated ray 202 minus reflected ray 204, or ((1−Γ)Φ)−(Γ(1−Γ)Φ), which can be rewritten as (1−Γ)²Φ. Transmitted ray 206 emerges from wall 120 and continues on towards target 130. Ray 206 hits target 130, and is reflected back towards wall 120 as reflected ray 208.

While transmitted ray 206 travels towards target 130, reflected ray 204 begins its traverse back through wall 120 from back surface 124 towards front surface 122. Ray 204 is attenuated by proportion Φ by its traversal of wall 120, such that its magnitude as it reaches front surface 122 is Γ(1−Γ)Φ². At front surface, part of ray 204 is reflected back into wall 120 as ray 218, and the remainder of ray 204 is transmitted through front surface 122 of wall 120 as ray 220. The magnitude of reflected ray 218 is Γ²(1−Γ)Φ² at front surface 122 of wall 120. The magnitude of transmitted ray 220 is equal to the magnitude of ray 204 at front surface 122 minus the magnitude or reflected ray 218 at front surface 122, namely (Γ(1−Γ)Φ²)−(Γ²(1Γ)Φ²), which can be rewritten as Γ(1−Γ)²Φ². Transmitted ray 220 proceeds towards radar station 110, where it arrives with magnitude Γ(1−Γ)²Φ² at time t₂.

Turning back to ray 206 (i.e. the first part of original signal 115 that impinges on target 130), a portion of ray 206 is reflected by target 130 as ray 208. The magnitude of ray 208 is a proportion of the magnitude of ray 206 that depends on the size and reflectivity of target 120. Assuming that the proportion of incoming ray 206 is reflected back by target 130, then the magnitude of reflected ray 208 is ρ(1−Γ)²Φ, where ρ is target's reflectivity.

On its return trip from target 130, ray 208 hits back surface 124 of wall 120, where a portion is reflected as ray 210 and the remaining portion is transmitted into wall 120 as ray 212. The magnitude of reflected ray 210 is Γ(ρ(1−Γ)²Φ). The magnitude of transmitted ray 212 at back surface 124 of wall 120 is ρ(1−Γ)²Φ²−Γ(ρ(1−Γ)²Φ), which can be rewritten as ρ(1−Γ)³Φ.

Ray 212 is attenuated as it traverses wall 120 from back surface 124 to front surface 122, reaching front surface 122 with a magnitude of Φ(ρ(1−Γ)³Φ) which equals ρ(1−Γ)³Φ².

At front surface 122, ray 212 is partially reflected as ray 214. The remaining portion of ray 212 is transmitted through front surface 122 as ray 216. The magnitude of reflected ray 214 is Γ(ρ(1−Γ)³Φ²). The magnitude of transmitted ray 216 is ρ(1−Γ)³Φ²−Γ(ρ(1−Γ)³Φ²), which can be rewritten as ρ(1−Γ)⁴Φ². Finally, ray 216 is received by radar station 110 with the magnitude of ρ(1−Γ)⁴Φ² at time t₃. Ray 216 is thus the third (in time) ray received by radar station 110 (after rays 200 and 220), but is the first ray that is received that carries information about target 130.

Additional rays continue their back and forth traversal through wall 120, some reflecting off target 130, eventually being received by radar station 110, with successively attenuated magnitudes.

As is evident from the discussion of FIG. 2 above, the signals received by radar station 110 in response to sending out original signal 115 is a complex mixture of signals reflected by and through wall 120 and those reflected by target 130. To be able to properly perceive target 130, the extraneous signals caused by reflections by and within wall 120 must somehow be identified and removed. This process, which may be viewed as canceling out the effect of the wall, is sometimes referred to as “dewalling”.

One way to “dewall” a radar image is to take a radar image of the location of interest without a target present, thereby recording the background radar signature of the location (including the walls). That background radar signature can be removed from the received signals, leaving, theoretically, the radar signals reflected from the target. Such a method for subtracting background radar signals from a received radar signal is described, for example, in Greg Barrie, “UWB Impulse Radar Characterization and Processing Techniques,” Technical Report, DRDC Ottawa TR 2004-251. However, to use this technique, the location of interest must be known ahead of time, and the opportunity must exist to take such a characterization radar image using the same equipment from the same location as will be used when the target is present. In many circumstances, that will not be practical.

If the characteristics of the wall (e.g. thickness and permittivity) are adequately known, then processing tools exist that can, given enough time and processing power, remove some of the extraneous signals, thereby making the signals that have been reflected by the target easier to perceive. However, in a practical application, such as seeking to identify enemy agents inside a building, the wall characteristics will typically not be known.

One method to estimate the characteristics of a wall from an outside surface of the wall is proposed in Kong Ling-jiang; Guo-long Cui; Jian-yu Yang; Xiao-bo Yang; “Wall parameters estimation method for through-the-wall radar imaging,” Radar, 2008 International Conference on, vol., no., pp. 297-301, 2-5 Sep. 2008. The proposed method involves placing two antennas (transmitting and receiving) at a known separation against the wall in question. The characteristics of the wall are estimated from the form of the signal received at the receiving antenna from the transmitting antenna. A drawback of this system is that it requires access to the wall in question before the target in question.

What is needed is a method to obtain estimates of the characteristics of a shielding wall or other obstacle from the same radar signal used to image the intended target, at the time of imaging.

### BRIEF SUMMARY OF THE INVENTION

The present invention comprises a method for through the wall radar imaging. In the present invention, an impulse synthetic aperture radar system (“ImpSAR™”) transmits short, ultra-wideband (“UWB”) carrierless microwave pulses at an obstacle behind which a target of interest is located. For each transmitted pulse, the return signals are received, stored and analyzed. Portions of the return signals that represent reflections from the obstacle are identified and analyzed in the time domain to estimate the transmission coefficient of the wall, either by estimating wall parameters or by using a novel shift and add procedure. The estimated transmission coefficient is used to filter the received signals to reduce the components of the received signal that are generated by the obstacle, and to compensate for distortion caused by the obstacle in the portions of the transmitted signal that are reflected by the target and returned, through the obstacle, to the radar system. In one or more embodiments, the received signal is divided into separate frequency “slices,” and the process of the invention is applied separately to each frequency “slice.”

### BRIEF DESCRIPTION OF THE DRAWINGS

FIG. 1 is a schematic diagram of a through-the-wall imaging scenario.

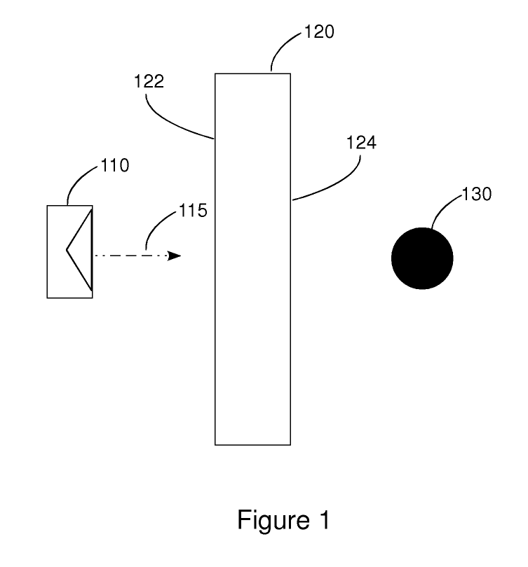

FIG. 2 is a schematic time space diagram illustrating the progression of a radar signal in the scenario of FIG. 1.

FIG. 3 is a graph illustrating an impulse reflected from the wall for a rectangular pulse of unit amplitude. Assumed wall parameters are ∈ᵣ=6, normalized electrical thickness value t_{w}=2.5, and normalized time width of the pulse is T′=0.25.

FIG. 4 is a flow chart showing the basic steps of an embodiment of the present invention.

FIG. 5 is a flow chart showing a process used in one or more embodiments of the invention for determining wall characteristics from a reflected signal.

FIG. 6 is a flow chart showing a process used in one or more embodiments of the invention for creating a dewalled image according to one or more embodiments of the invention.

FIG. 7 shows a schematic of an embodiment of a Polychromatic SAR™ system.

FIG. 8 shows a flow chart for using Polychromatic SAR™ in one or more embodiments of the invention.

FIG. 9 is a flow chart showing a process for obtaining a transmitted field from a reflected signal according to one or more embodiments of the invention.

FIG. 10 shows a simulated signal received in free space from a target in one or more embodiments of the invention.

FIG. 11 shows a simulated signal received from a wall and a target in one or more embodiments of the invention.

FIG. 12 shows a simulated signal resulting from applying the process of FIGS. 9 and 6 to the simulated signal of FIG. 11 in one or more embodiments of the invention.

### DETAILED DESCRIPTION OF THE INVENTION

The present invention comprises a method for through the wall (or other obstacle) radar imaging. In the present invention, an impulse synthetic aperture radar system, such as, for example, an ImpSAR™ impulse synthetic aperture radar system from Eureka Aerospace, Inc., may be used. Synthetic aperture radar (“SAR”) is a known way to synthesize a long antenna (needed to obtain improved cross-range target resolution) by using a small element antenna moving in a rectilinear path, which could be parallel to the side of the wall. In an impulse SAR system, the signals that are transmitted by the antenna are short, carrierless UWB impulses. At each of a plurality of discrete positions along its movement, the element antenna radiates a UWB impulse toward the wall and records the received signal, scattered back by the wall and the inside target. The result, after processing of the signals received at each location, approximates using a much longer antenna array comprising a number of elementary antennas equal to the number of pulses emitted and received. An advantage of transmitting carrierless UWB impulses instead of conventional narrowband pulses is that processing of the received signals can be carried out in the time domain. In conventional radar systems, processing must account for the presence of a sinusoidal carrier signal, and operates in the frequency domain, which requires the use of Fourier transforms and filters. All this requires considerable processing time, unless computer clusters are adopted, which is not convenient within disaster or battle-field areas. By using carrierless impulses, the processing may be fully performed in the time-domain, with simpler procedures. For each imaged point, the successive received pulses are shifted to be synchronized in time, and then added together, such that processing in real time can be achieved.

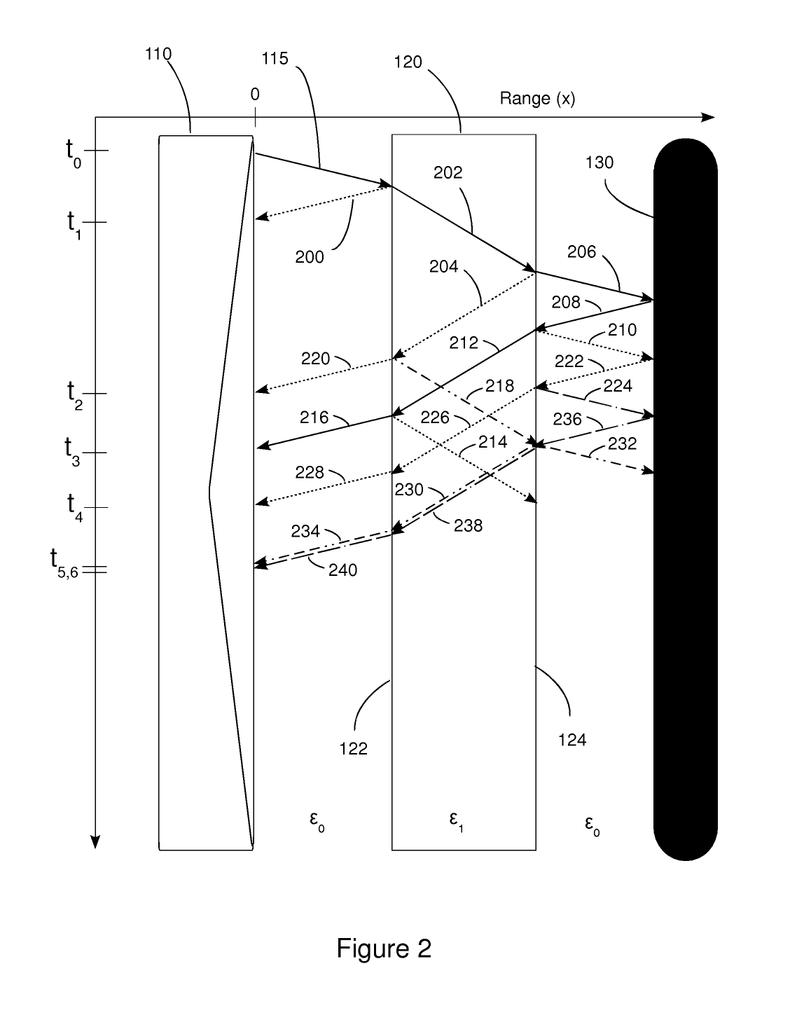

The present invention is directed at the elimination, or minimization of the presence of the wall in the resulting image. As described above with respect to FIG. 2, the radiated field strikes the wall, and is partly reflected. Then, it penetrates through the wall, enters in the shielded area, impinges on the target, is reflected toward the wall, is again partly reflected, penetrates the wall along the opposite direction, and is finally received by the radar system. However, this propagation pattern is not unique: when the electromagnetic signal strikes one face of the wall, and partly penetrates and propagates inside it, it strikes the second face of the wall, and is partly reflected inside the wall again. This pattern is repeated again, although with field intensities successfully decreasing, but in any case different from zero. Accordingly, the signal moves along back-and-forth directions inside the wall, and successive increasingly attenuated replicas of the transmitted signal are received at the radar station, corresponding to successive separated lines, due to longer propagation lengths, over the final image. Those lines, due to the presence of the wall, may spatially superpose to the target image, creating confusion and error: accordingly, they should be somehow cancelled.

For conventional radar, filtering the wall generated signal is in principle possible, although no completely successful example has been demonstrated. Part of the reason is that the filter procedure for conventional radar systems must be implemented in the frequency domain, which is conceptually difficult and requires complex processing. Use of carrierless UWB impulses, as in the present invention, however, allows processing to be performed in the time-domain, which is more straightforward and understandable and can lead to close to real time results.

As shown in FIG. 2, the first two return signals that reach radar station 115 are signal 200, which is reflected from front surface 122 of wall 120, and signal 220, which is traverses wall 120, is reflected by back surface 124, traverses back through wall 120, emerges from front surface 122, and then returns to radar station 115.

If the signals transmitted by the radar station 115 are extremely short, UWB impulses, as used in the present invention, then the return signals show up as distinct pulses in the signal received by radar station 115 if the duration of the transmitted impulse is less than the difference in arrival times of the return signals. For impulses on the order of 100 picoseconds (ps) or less, as used in the present invention, that will often be the case. These first two signals can each be easily isolated by appropriate time windows. They contain several types of information about the wall that can, by proper processing, be extracted. Because first return ray 200 is reflected directly back to radar system 115 by front surface 122 of wall 120, its amplitude is related to the reflectivity of the wall, which may be represented by a reflection coefficient. The magnitude or the second return ray 220 is also affected by the reflection coefficient of wall 120 (when it bounces off the inside of back surface 124 of wall 120). In addition, because it also traverses back and forth through wall 120, the magnitude of the second return ray is also affected by the transmissivity of the wall material and the width of the wall. In addition, the signal is dispersed by the wall material, causing a distortion of its pulse shape. Accordingly the magnitude and shape of second return signal 220, and the time length between the arrival of first and second return signals 200 and 220, carry information about the transmissivity and reflectivity of the wall, as well as information about its thickness.

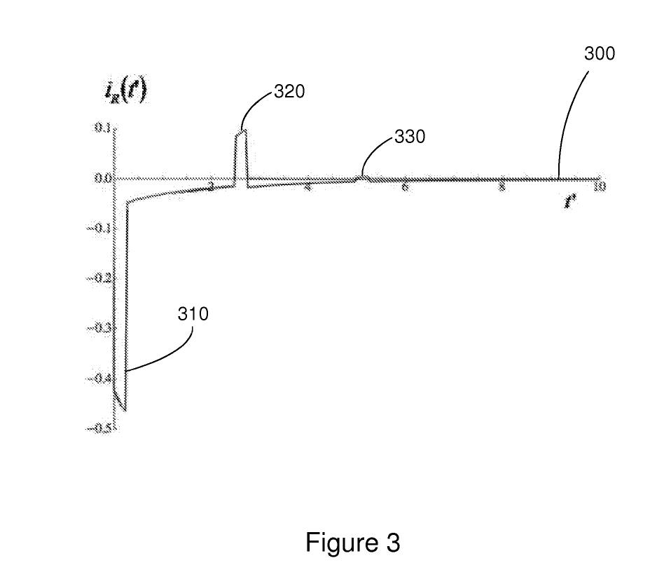

FIG. 3 shows an example of a return signal 300 received by radar station 115 in response to a single emitted pulse. Return signal 300 represents the entire reflected field, i.e. all of the signals of the field coming out from the wall as depicted in FIG. 2. For simplicity here the assumed incident field is a rectangular pulse; the wall is homogeneous of concrete type; the time is represented along the horizontal line, and the amplitude of the received signal is represented by the vertical axis.

In FIG. 3, the structure of the reflected field is immediately apparent: it consists of a number of pulses (“bounces”), separated by equal propagation times. The first “bounce” 310 represents first reflected signal 200 of FIG. 2, and the second “bounce” 320 represents second reflected signal 220 of FIG. 2. The successive bounces are increasingly attenuated (see, e.g. “bounce” 330), and their shape is deformed, compared to the simple rectangular incident pulse.

Embodiments of the invention utilize two alternative approaches to dewalling: one that derives wall parameters such as the reflection coefficient, dielectric constant, conductivity, wall thickness, and/or wall electrical length from the signals received by the receiver, and a second that estimates the wall electrical length and the reflection coefficient from the received signals. The second approach is the most simple and efficient one, although its robustness is limited to walls with very small losses (σ<0.001). In one or more embodiments of the invention, pertinent characteristics of the wall are determined from the first and second bounces 310 and 320 of FIG. 3. In the first approach, in one or more embodiments, the dielectric constant of the wall is determined from the initial amplitude of the first bounce 310. Knowing the dielectric constant, the conductivity and wall thickness are determined from the ratio between the initial values of the second bounce 320 and the first bounce 310 and the time delay in-between the two bounces. At this point all information needed to compute the transmissivity of the wall has been recovered, and several techniques may be implemented to “clean” the microwave image of the target, eliminating (or at least reducing) the presence of the wall. In the second approach, ratio between the first and second bounces 310 and 320 of FIG. 3 is used to determine the reflection coefficient. After shifting and adding the reflected field in the time domain, it is possible to obtain transmitted field without calculation of any other wall parameters, except for the wall electrical length. The “cleaning” of the microwave image of the target from this step onward is identical to that in the first approach.

The above mentioned innovative procedure requires an additional innovative measurement protocol, because in the system usage the incident field is not necessarily a clean rectangular pulse. But this problem can be solved by properly elaborated successive implementation of known protocols. By utilizing the method of the invention, estimates of the transmission coefficient, reflection coefficient, and thickness of the wall are extracted, and then applied to the whole received signal to eliminate or reduce the effect of the wall, thereby enhancing the detectability of the target in the resulting radar image.

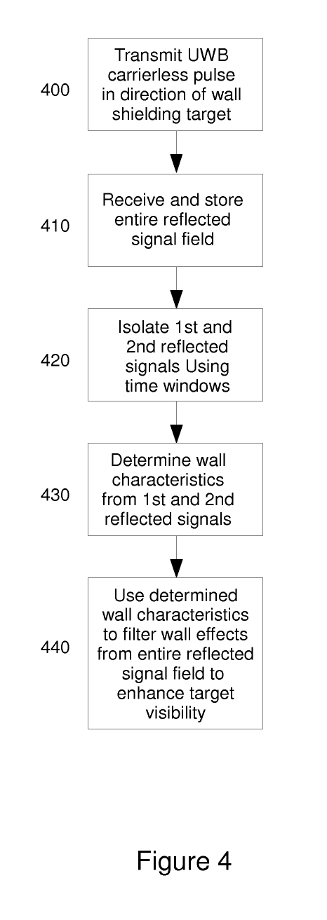

FIG. 4 is a flow chart showing the basic steps of an embodiment of the present invention. In the embodiment of FIG. 4, a carrierless UWB pulse is transmitted in the direction of a wall shielding the target of interest at step 400. At step 410, the entire reflected signal field resulting from the transmitted pulse is received and stored. At step 420, the first and second reflected signals are isolated using appropriate time window(s). Alternatively, if it is desired to obtain the wall parameters prior to detecting the target, steps 410 and 420 may be combined, so that the reflected field is measured only within the selected time window(s). Also, in one or more embodiments, the time window may be chosen to capture additional bounces beyond the first and second reflected signals. At step 430, the wall characteristics (e.g. dielectric coefficient, conductivity and wall thickness in first approach, and wall electrical length and reflection coefficient in second approach) are determined from the first and second (or more) reflected signals. At step 440, the determined wall characteristics are used to filter the effects of the wall from the entire reflected signal field, enhancing the visibility of the target in the resulting radar image.

### Theoretical Background

As discussed above, the practical feasibility of the present invention results in part from the implementation of novel time domain processing methods in the present invention. A discussion of the theoretical background of the time domain processing methods of the present invention are set forth in the unpublished paper entitled “Through-the-Wall Pulse Propagation Without All the Mess Contribution” which is attached as Appendix A and incorporated by reference in its entirety herein.

### Approach 1: Obtaining Wall Parameters and Calculating Transmission Coefficient

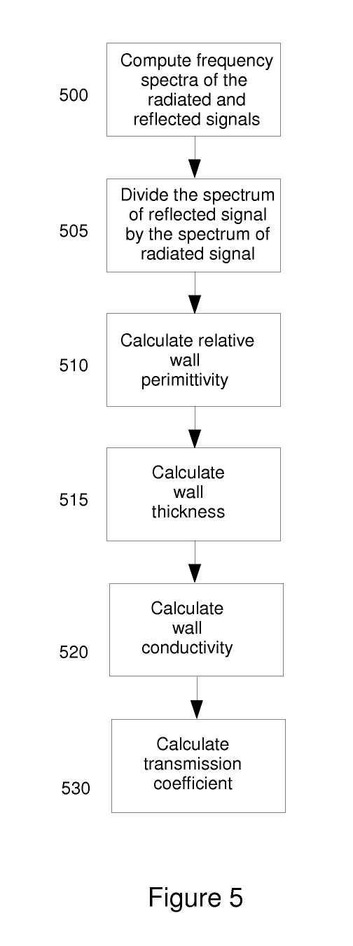

FIG. 5 is a flow chart showing a process used in one or more embodiments of the invention for determining wall characteristics from a reflected signal. The process of FIG. 5 may be used, for example, in step 430 of FIG. 4, and may be implemented, for example, by computer software running on a computer system.

As shown in FIG. 5, the frequency spectra (i.e., FTs) of the radiated and reflected signals are calculated at step 500. At step 505, the spectrum of the reflected signal is divided by the spectrum of the radiated signal. This ratio is the spectrum of the reflection field. For a transmitted signal that is a rectangular pulse of unit amplitude with normalized width T′=0.25, the field reflected from the wall will look similar to that depicted in FIG. 3. In one or more embodiments, the reflection impulse response is approximated according to the expression:

$${\hat{h}}_{R} ( t ) = [ γ δ ( t ) - ( 1 + γ ) \frac{1}{τ} {\hat{g}}_{0}^{″} ( t ) U ( t ) ] - γ ( 1 - {γ}^{2} ) [ exp ( - \frac{{t}_{w}}{τ} ) δ ( t - 2 {t}_{w} ) - \frac{1}{τ} {\hat{g}}_{2}^{″} ( t ) U ( t - 2 {t}_{w} ) ] - {γ}^{3} ( 1 - {γ}^{2} ) [ exp ( - \frac{2 {t}_{w}}{τ} ) δ ( t - 4 {t}_{w} ) - \frac{1}{τ} {\hat{g}}_{4}^{″} ( t ) U ( t - 4 {t}_{w} ) ] - {γ}^{5} ( 1 - {γ}^{2} )$$

In the above expression, each bracketed term represents a distinct bounce (the definition of each of the variables is set forth in Appendix A). Each bracketed bounce term contains two parts: attenuated pulse, represented by the delta function term, and dispersion term. For calculation of wall parameters, it is sufficient to know only the delta function terms of the first two bounces. To obtain an appropriate corresponding expression for radiated signal ƒ(t), it is necessary to convolve ĥ_{R}(t) with ƒ(t).

At step 510 of FIG. 5, the relative wall permittivity is calculated. For a transmitted pulse described by equation ƒ(t), amplitude of reflected field at t=0 is given by γƒ(t). The amplitude of the first pulse should be equal to γƒ(t₀), but for at least a scaling factor, because incident and reflected fields have not been necessarily measured at the same location. Accordingly, a more robust approach is to evaluate γ via the absolute ratio of the amplitudes of the second and first pulses, instead of using just the first reflected pulse. Letting u=1−γ² denote this ratio, the resulting equation can be solved for the value of γ.

We know that

$$y = - \frac{\sqrt{{ɛ}_{r}} - 1}{\sqrt{{ɛ}_{r}} + 1} ,$$

where ∈ᵣ is the relative permittivity of the wall. Hence, the relative permittivity of the wall can be calculated as

$${ɛ}_{r} = {( \frac{1 - γ}{1 + γ} )}^{2} .$$

Having calculated the relative permittivity of the wall, the wall thickness is calculated at step 515 using the time difference between two successive bounces as obtained from the measured reflected field (e.g. the time between signals 310 and 320 of FIG. 3). The time difference between two successive bounces is 2t_{w}, where

$${t}_{w} = \frac{\sqrt{{ɛ}_{r}} b}{c} ,$$

b is the wall thickness and c is the speed of light. Letting “B” be the value of 2t_{w} obtained from the measured reflected signal, and having calculated ∈ᵣ, the value of b can be obtained from the expression

$$b = \frac{Bc}{2 \sqrt{{ɛ}_{r}}} .$$

Having calculated the relative permittivity and the wall thickness, the wall conductivity is calculated at step 520 based on the amplitude of the second bounce (e.g. the amplitude of signal 320 in FIG. 3). Let the amplitude of that bounce be A₂. This amplitude is equivalent to −γ(1−γ²)e^{-t}^{_{w}}^{/τ} (amplitude of the attenuated pulse part of the second bounce), where τ=∈₀∈ᵣ/σ is the relaxation time of the material, σ is conductivity of the material, and ∈₀ is free-space permittivity. τ can then be calculated according to the expression

$$τ = \frac{- {t}_{w}}{log ( - \frac{{A}_{2}}{γ ( 1 - {γ}^{2} )} )} .$$

From τ, the wall conductivity is obtained from the expression σ=∈₀∈ᵣ/σ, where ∈₀ is known and σ and ∈ᵣ have already been calculated.

An example of using the method of FIG. 5 to calculate wall parameter values is as follows. Suppose we have a wall with relaxation time τ=5 nsec. We transmit a rectangular pulse of width T=1.25 nsec and unit amplitude. For a wall with ∈ᵣ=6 and electrical thickness value t_{w}=6.25 nsec, the reflected field will be as depicted in FIG. 3. In non-normalised time domain, the x-axis will be 5 nsec times the x-axis depicted in the figure. As observed from the FIG. 3, we calculate γ to be equal to −0.42. Then

$${ɛ}_{r} = {( \frac{1 - γ}{1 + γ} )}^{2} = 5.9941$$

(which is close to the actual value of 6).

Now, time difference observed from FIG. 3 between the two bounces (signals 310 and 320 in FIG. 3) is B=2.5*5 nsec=12.5 nsec=2t_{w}. From that, t_{w}=6.25 nsec, which is exact value of t_{w}. Then, calculating wall thickness we have

$$b = \frac{Bc}{2 \sqrt{{ɛ}_{r}}} = 0.7658 m = 76.58 cm .$$

The actual thickness is given by b=0.7658 m=76.58 cm, so the estimate is the same as the actual value. As observed from FIG. 3, amplitude of the second bounce (signal 320 in FIG. 3) is A₂=0.09. Then calculating

$$τ = \frac{- {t}_{w}}{log ( - \frac{{A}_{2}}{γ ( 1 - {γ}^{2} )} )}$$

gives τ=4.6421 nsec, which is close to the actual relaxation time of 5 nsec. Then, using free space permittivity ∈₀=8.85*10⁻¹²⁻ F/m, σ=∈₀∈ᵣ/τ=0.0114 siemens/m. The actual conductivity is 0.0106 siemens/m.

Thus, just using the information about the non-dispersive parts of the first two bounces, it is possible to successfully estimate all the wall parameters.

At step 530, the transmission coefficient in the frequency domain is calculated using the estimated wall parameters from the expression

$${T}^{⋒} = \frac{( 1 - {Γ}^{2} ) exp ( - i φ )}{1 - {Γ}^{2} exp ( - 2 iφ )} ,$$

where

$$Γ ( ω ) = - \frac{\sqrt{ɛ ( ω )} - 1}{\sqrt{ɛ ( ω )} + 1} , \\ ɛ = {ɛ}_{r} - i \frac{σ}{ω {ɛ}_{0}} = {ɛ}_{r} - i \frac{{σζ}_{0} c}{ω} = {ɛ}_{r} [ 1 + \frac{1}{iω τ} ] , \\ and$$

$$i φ = i ω \sqrt{ɛ} \frac{b}{c} .$$

### Approach 2: Shift and Add to Obtain Transmission Coefficient

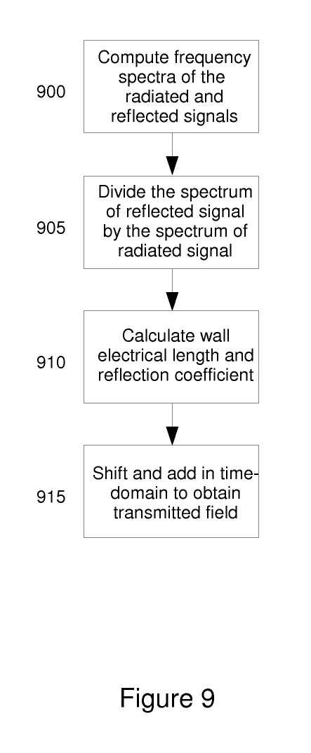

FIG. 9 is a flow chart showing a process used in one or more embodiments of the invention for determining necessary wall characteristics from a reflected signal.

At steps 900 and 905, the reflected field is calculated in the same manner as in the embodiment of FIG. 5 by computing the frequency spectra of the radiated and reflected signals at step 900 and dividing the spectrum of the reflected signal by the spectrum of the radiated signal at step 905.

At step 910, the wall electrical length and reflection coefficient are calculated as follows. The time spacing between consecutive pulses, 2t_{w}, can be estimated from the graph of reflected field. γ is calculated as described in paragraph [0052] of Approach 1.

At step 915, the transmitted field is obtained by shifting and adding the reflected field in the time domain as follows. Denoting the incident field as ƒ(t) and reflected field as ƒ_{R}(t), which can be shown to be equal to

$${f}_{R} ( t ) = γ f ( t ) - ( 1 - {γ}^{2} ) {\sum }_{n = 1}^{∞} {γ}^{2 n - 1} f ( t - 2 n {t}_{w} ) ,$$

ƒ_{R}(t) can be written as a sum of two parts, ƒ_{R1}(t) and ƒ_{R2}(t), where

$${f}_{R 1} ( t ) = {\sum }_{n = 0}^{∞} {γ}^{2 n + 1} f ( t - 2 n {t}_{w} ) = γ f ( t ) + {γ}^{3} f ( t - 2 {t}_{w} ) + …$$

$$and$$

$${f}_{R 2} ( t ) = - {\sum }_{n = 1}^{∞} {γ}^{2 n - 1} f ( t - 2 n {t}_{w} ) = - γ f ( t - 2 {t}_{w} ) - {γ}^{3} f ( t - 4 {t}_{w} ) - … .$$

Time-shifting ƒ_{R}(t) by 2t_{w} and adding the result to ƒ_{R}(t) gives ƒ_{R}(t)+ƒ_{R}(t−2t_{w})=ƒ_{R1}(t)+ƒ_{R2}(t−2t_{w}). The conclusion is that the new graph is again the sum of two contributions, with the second one shifted in time by 4t_{w} instead of 2t_{w}. It is clear that iteration of the procedure will sufficiently shift ƒ_{R2}(t), so that ƒ_{R1}(t) is recovered.

The transmitted field is given by

$${f}_{T} ( t ) = ( 1 - {γ}^{2} ) {\sum }_{n = 0}^{∞} {γ}^{2 n} f ( t - ( 2 n + 1 ) {t}_{w} ) ,$$

and is hence equal to

$${f}_{T} ( t ) = \frac{1 - {γ}^{2}}{γ} {f}_{R 1} ( t - {t}_{w} ) .$$

From this, the spectrum of the transmission coefficient can be calculated in the frequency domain in a straightforward manner.

### Applying the Transmission Coefficient

The spectrum of the received backscattered field from the target, \hat{R}(ω), is the following one:

$$\hat{R} ( ω ) = F ( ω ) \frac{exp ( - i \frac{ω}{c} {r}^{′} ) \hat{T} ( ω ) exp ( - i \frac{ω}{c} {r}^{″} )}{4 π ( {r}^{′} + {r}^{″} )} S ( ω ) \frac{exp ( - i \frac{ω}{c} {r}^{″} ) \hat{T} ( ω ) ( - i \frac{ω}{c} {r}^{′} )}{4 π ( {r}^{′} + {r}^{″} )} A ( ω ) = F ( ω ) \frac{exp ( - 2 i \frac{ω}{c} [ {r}^{′} + {r}^{″} ] ) {\hat{T}}^{2} ( ω )}{{[ 4 π ( {r}^{′} + {r}^{″} ) ]}^{2}} S ( ω ) A ( ω ) ,$$

where r′ is the distance from transmitter to the wall, d is the thickness of the wall, and d″ is the distance from the other side of the wall to the target. F(ω) is the spectrum of the transmitted field, \hat{T}(ω) is the spectrum of the transmission coefficient through all the wall, S(ω) is the spectrum of the scattering coefficient of the target, and A(ω) is the spectrum of the transfer function of the receiving antenna. The spectrum of the received backscattered field from the wall, R(ω), is

$$R ( ω ) = F ( ω ) \frac{\hat{Γ} ( ω ) exp ( - i \frac{ω}{c} 2 {r}^{′} )}{4 π ( 2 {r}^{′} )}$$

A(ω), where \hat{Γ}(ω) is the spectrum of the reflection coefficient of the entire wall.

Note that neither \hat{R}(ω) nor R(ω) is measured analytically. What is measured and computed is the reflected field, which is the inverse Fourier transform of the sum of the two fields \hat{R}(ω) and R(ω). For our purpose, it is necessary to separate the returns from the wall and the returns from the target. To construct the returns from the wall, it is necessary to obtain the first bounce, which has already been obtained as described in paragraph [0051] using time window. Let's denote this first bounce as by r̅(t), whose analytical expression is

$$\overline{r} ( t ) = \frac{1}{4 π ( 2 {r}^{′} )} {FT}^{- 1} [ F ( ω ) exp ( - i \frac{ω}{c} 2 {r}^{′} ) Γ ( ω ) A ( ω ) ] .$$

The following bounces from the wall are simply r̅(t) shifted in time by multiples of 2t_{w} and scaled by the factor γ², both of which have been calculated in previous sections. Thus, the second bounce from the wall is given by γ² r̅(t−2t_{w}), the third bounce is γ⁴ r̅(t−4t_{w}), etc. Adding the constructed bounces together, we obtain return from the wall r(t). Return from the target is simply the difference between reflected field and r(t). Let's denote this difference as \hat{r}(t).

Now, we can compute the two spectra,

$$\hat{R} ( ω ) = FT [ \hat{r} ( t ) ] = \frac{1}{{[ 4 π ( {r}^{′} + {r}^{″} ) ]}^{2}} [ F ( ω ) exp ( - 2 i \frac{ω}{c} [ {r}^{′} + {r}^{″} ] ) {\hat{T}}^{2} ( ω ) S ( ω ) A ( ω ) ]$$

$$and$$

$$\overline{Γ} ( ω ) = {FT}^{- 1} [ \overline{r} ( t ) ] = \frac{1}{4 π ( 2 {r}^{′} )} F ( ω ) exp ( - i \frac{ω}{c} 2 {r}^{′} ) Γ ( ω ) A ( ω ) .$$

An effective way to dewall is to compute the ratio

$$\frac{\hat{R} ( ω )}{{\overline{T}}^{2} ( ω )} {\overline{Γ}}^{2} ( ω ) ,$$

where T̅(ω) is the transmission coefficient, computed in the previous sections. Analytically, this ratio gives

$$\frac{\hat{R} ( ω )}{{\overline{T}}^{2} ( ω )} \overline{Γ} ( ω ) = {[ \frac{2 {r}^{′}}{{r}^{′} + {r}^{″}} ]}^{2} \frac{F ( ω ) exp ( - 2 i \frac{ω}{c} [ {r}^{′} + {r}^{″} ] ) {\hat{T}}^{2} ( ω ) S ( ω ) A ( ω )}{{[ F ( ω ) exp ( - i \frac{ω}{c} 2 {r}^{′} ) \hat{T} ( ω ) A ( ω ) ]}^{2}} \frac{F ( ω ) exp ( - i \frac{ω}{c} 2 {r}^{′} ) Γ ( ω ) A ( ω )}{4 π ( 2 {r}^{′} )} = {[ \frac{2 {r}^{′}}{{r}^{′} + {r}^{″}} ]}^{2} exp ( - 2 i \frac{ω}{c} {r}^{″} ) Γ ( ω ) \frac{S ( ω )}{4 π ( 2 {r}^{′} )}$$

In other words, it gives the image of target in free space, devoid of any presence of a wall or another obstacle, with exception of shift in time and a scaling factor, both of which are easily corrected.

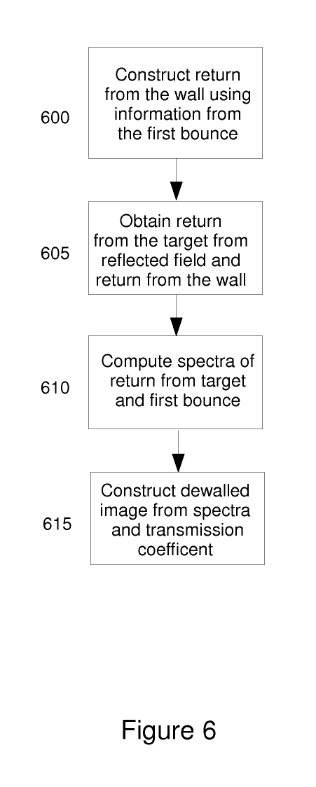

FIG. 6 is a flow chart illustrating the above process. At step 600, the return from the wall is constructed using information from the first bounce. At step 605, the return from the target is constructed from the reflected field and the return from the wall. The spectra of the return from the target and first bounce are computed at step 610. At step 615, the dewalled image is constructed using the spectra computed in step 610 and the transmission coefficient obtained, for example, using either of the methods described above.

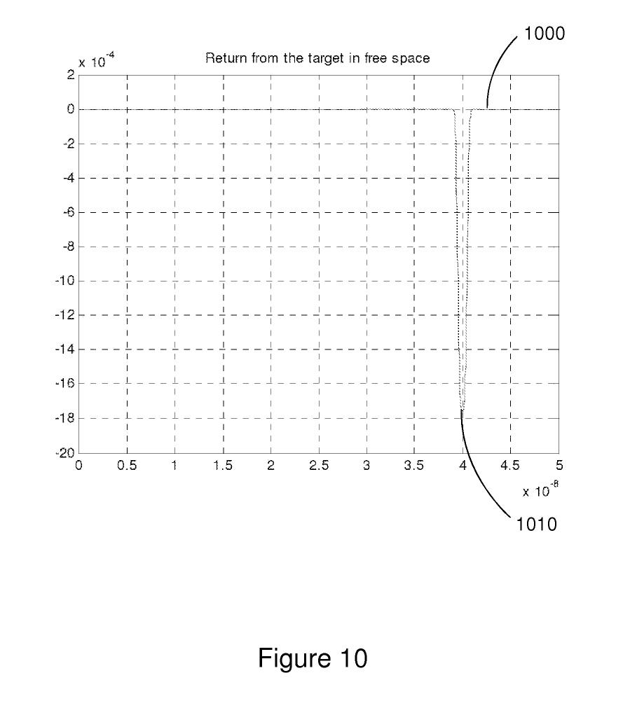

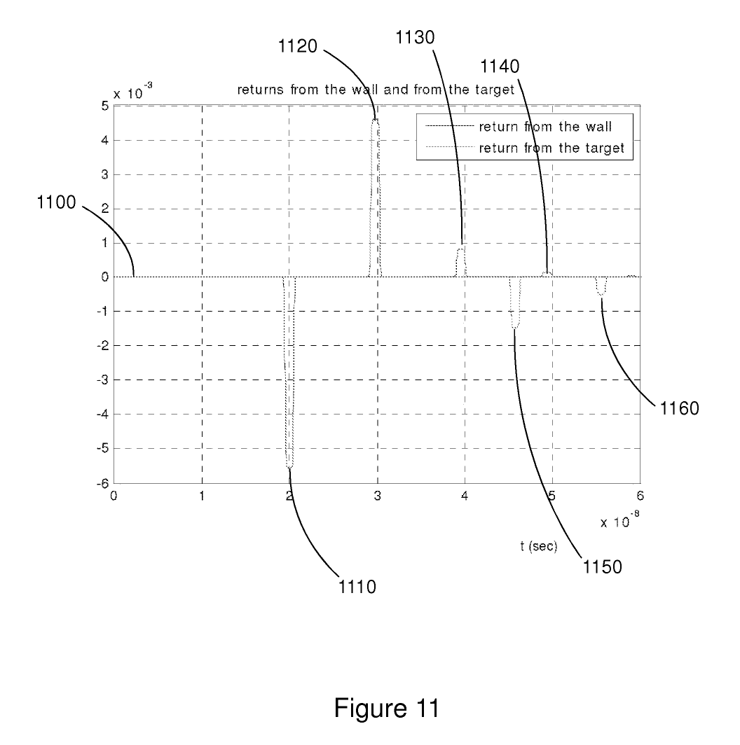

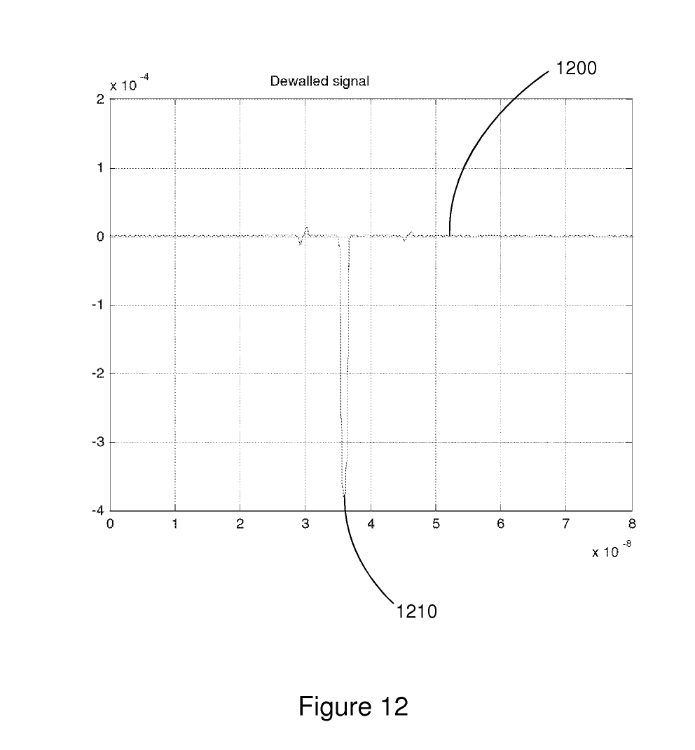

FIGS. 10-12 show a simulated implementation of the methods of FIGS. 9 and 6. The assumptions for the set-up were as follows: the wall is homogeneous and lossless; distance from the wall antenna to the wall is 3 m; thickness of the wall is 0.6 m; distance from the back of the wall to a point target behind it is 2.4 m; scattering coefficient of the target is −10, and ∈ᵣ=6. FIG. 10 shows the signal 1000 that is received from the target in free space, that is, without a wall or other obstacle between the transmitter and the target. Signal 1000 includes a single pulse 1010 that is reflected from the target. FIG. 11 shows the signal 1100 received with the target behind the wall. Signal 1100 includes pulses 1110, 1120, 1130 and 1140 reflected from the wall, and pulses 1150 and 1160 reflected by the target. FIG. 12 shows the signal 1200 resulting from applying the “shift and add” method for obtaining the transmission coefficient of FIG. 9 and the consequent dewalling as described in the above paragraphs. Comparing FIG. 12 to FIG. 10, it is clear that pulse 1210 of signal 1200 almost identical in shape to pulse 1010 of signal 1000 in FIG. 10. Hence, this procedure is an effective way to eliminate the effects of the wall.

### Embodiment Using Polychromatic SAR™

In one or more embodiments, the dewalling procedure of the present invention may be implemented using a process that is sometimes referred to as “Polychromatic SAR™.” Polychromatic SAR™ takes advantage of the large bandwidth of an UWB emitted radar pulse to obtain greater resolution by separately processing different frequency “slices” of the received signal. Because the wall parameters are frequency dependent, the information available from each slice will be somewhat different, and combining the results of the separate processing of each slice potentially improves the results of dewalling and provides more details about the target (i.e. a higher resolution image) than when the entire signal is processed as a whole.

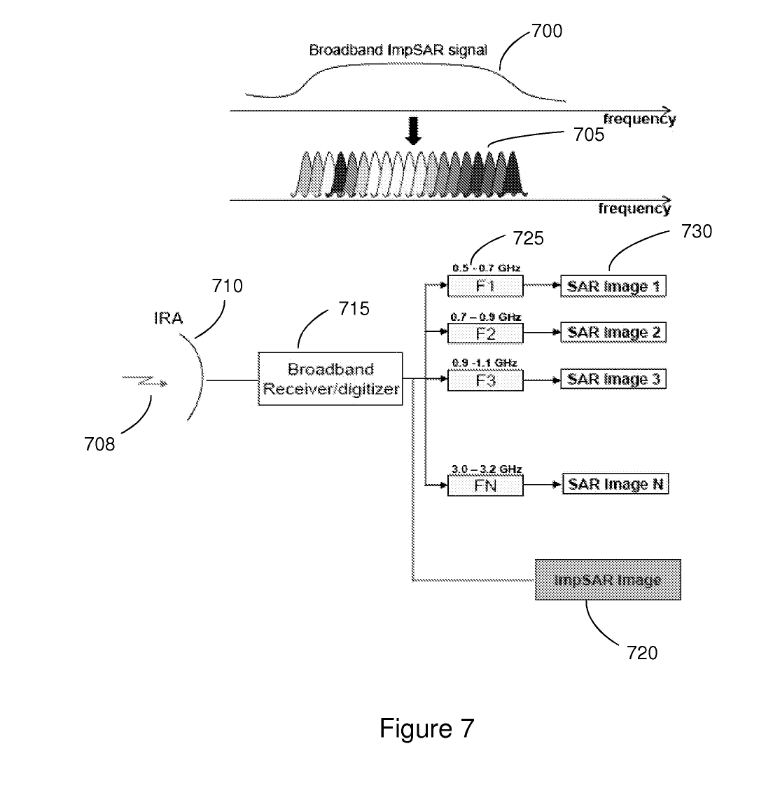

FIG. 7 shows a schematic of an embodiment of a Polychromatic SAR™ system. As shown in FIG. 7, a UWB impulse SAR signal 700 can be viewed as a combination of a plurality of narrow band signals 705. In the system of FIG. 7, the reflected field 708 from an impulse SAR pulse is received by radar antenna 710. The received reflected field is digitized by a broadband receiver/digitizer 715. In the system of FIG. 7, as in a conventional impulse SAR system, the entire received field 708 may be processed together to create an impulse SAR image 720. In addition, a plurality of bandpass filters 725 are applied to the received reflected field 708 to isolate discrete narrow bands of reflected field 708. Each of the resulting narrow band signals are then processed to produce a plurality of individual images 730. The individual images 730 can be viewed separately, or can be combined to produce an image with enhanced resolution.

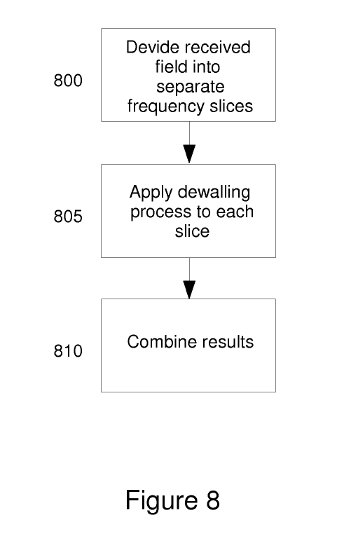

FIG. 8 shows a flow chart for using Polychromatic SAR™ in one or more embodiments of the invention. In the embodiment of FIG. 8, the received reflected field is divided into separate narrow band “slices” at step 800. At step 805, a dewalling process of the invention (such as, for example, the process of FIG. 4 and/or FIG. 6 and/or FIG. 9) is applied to each narrowband “slice.” At step 810, the results are combined to produce an enhanced target image.

Thus, a method and apparatus for through-the-wall radar imaging has been described. Although the present invention has been described with respect to certain specific embodiments, it will be apparent to those skilled in the art that the inventive features of the present invention are applicable to other embodiments as well, all of which are intended to fall within the scope of the present invention as set forth in the claims. For example, although the method has been described with respect to examples where the obstacle shielding a target is a wall, the method is applicable to other types of obstacles, including, without limitation, ground (e.g. buried targets), trees, and other animate or inanimate objects and structures. Further, the method is applicable to moving as well as stationary targets, and to applications where the obstacle shielding the target changes or moves over time.

What is claimed is:

1. A method for creating by a signal processing apparatus a radar image of a target located behind an obstacle comprising the steps of:
transmitting by a transmitter a radiated signal comprising an UWB carrierless pulse at the obstacle;
receiving by a receiver a reflected signal, said reflected signal comprising a first reflected field backscattered from the obstacle and a second reflected field backscattered from said target;
determining by said signal processing apparatus a transmission coefficient using said first reflected field;
creating by said signal processing apparatus said radar image from said reflected signal and said transmission coefficient.

2. The method of claim 1 wherein said step of determining said transmission coefficient comprises determining spectra of said radiated signal and said reflected signal.

3. The method of claim 2 wherein said step of determining said transmission coefficient comprises dividing said spectrum of said reflected signal by said spectrum of said radiated signal.

4. The method of claim 3 wherein said step of determining said transmission coefficient comprises identifying first and second components of said reflected signal.

5. The method of claim 4 wherein said step of determining said transmission coefficient comprises determining a time interval between said first and second components of said reflected signal.

6. The method of claim 5 wherein said step of determining said transmission coefficient comprises time shifting portions of said reflected signal by a multiple of said time interval.

7. The method of claim 5 wherein said step of determining said transmission coefficient comprises calculating a relative permittivity of said obstacle.

8. The method of claim 7 wherein said step of determining said transmission coefficient comprises determining a thickness of said obstacle.

9. The method of claim 7 wherein said step of determining said transmission coefficient comprises determining a conductivity of said obstacle.

10. The method of claim 4 wherein said step of creating said radar image comprises determining said first reflected field using information from said first and second components.

11. The method of claim 10 wherein said step of creating said radar image comprises determining said second reflected field from said reflected signal and said first reflected field.

12. The method of claim 11 wherein said step of creating said radar image comprises computing a spectrum of said second reflected field.

13. The method of claim 1 wherein said obstacle comprises a wall.

14. A method for creating by a signal processing apparatus a radar image of a target located behind an obstacle comprising the steps of:
transmitting by a transmitter a radiated signal comprising an UWB carrierless pulse at the obstacle;
receiving by a receiver a reflected signal;
dividing said reflected signal by said signal processing apparatus into a plurality of frequency segments;
determining by said signal processing apparatus a plurality of transmission coefficients from said plurality of frequency segments of said reflected signal;
creating by said signal processing apparatus said radar image from said plurality of frequency segments and said plurality of transmission coefficients.

15. The method of claim 14 wherein at least one of said plurality of frequency segments of said reflected signal comprises a first reflected field reflected from said obstacle.

16. The method of claim 15 wherein said step of determining said plurality of transmission coefficients comprises determining characteristics of said obstacle from said first reflected field.

17. The method of claim 14 wherein a first plurality of said plurality of frequency segments of said reflected signal comprise segments of said first reflected field.

18. The method of claim 17 wherein aid step of determining said plurality of transmission coefficients comprises determining characteristics of said obstacle for each of said plurality of frequency segments.

19. The method of claim 17 wherein said step of determining said plurality of transmission coefficients comprises time shifting portions of each of said frequency segments of said reflected signal.

20. The method of claim 14 wherein said obstacle comprises a wall.
